(19) United States
(12) Patent Application Publication
(10) Pub. No.: US 2026/0331630 A1
(43) Pub. Date: Oct. 22, 2026

(54) SYSTEM AND METHOD FOR THERMAL MANAGEMENT AND DIMENSIONAL CONTROL OF A BATTERY ASSEMBLY

(71) Applicant: GM GLOBAL TECHNOLOGY OPERATIONS LLC, Detroit, MI (US)

(72) Inventors: David Hyland, Shelby Township, MI (US); Anthony Michael Coppola, Rochester Hills, MI (US); Stephan Wagner, Waterford, MI (US); Daniel Henderson, Howell, MI (US); Hugo Figueroa Rosas, Shelby Township, MI (US)

(73) Assignee: GM GLOBAL TECHNOLOGY OPERATIONS LLC, Detroit, MI (US)

(21) Appl. No.: 19/180,974

(22) Filed: Apr. 16, 2025

(51) Int. Cl. H01M 10/6555; H01M 10/625; H01M 10/643; H01M 10/653; H01M 50/213; H01M 50/291; B60L 50/64

(52) U.S. Cl. CPC H01M 10/6555; H01M 10/625; H01M 10/643; H01M 10/653; H01M 50/213; H01M 50/291; B60L 50/64; H01M 2220/20

(57) ABSTRACT

Systems and methods of thermal management and dimensional control of a battery system include forming ribbons to remove heat from a battery system. Battery cells are assembled in rows with each row disposed between two of the ribbons. Prior to assembling the battery cells in rows, subassemblies are formed, each of which includes one of the ribbons and one of the rows of battery cells in a pre-bonded cell row. The battery cells of each subassembly are fixed to the one of the ribbons by a first thermal interface material. Plural of the subassemblies are stacked after the battery cells of each subassembly are fixed to their respective one of the ribbons as one of the pre-bonded cell rows. The battery cells of each subassembly are secured to the ribbon of another subassembly by a second thermal interface material to form a battery module.

### INTRODUCTION

The technical field generally relates to batteries, and more particularly relates to battery assemblies and battery assembly methods using cell stacking techniques providing thermal management improvement and geometric precision for use in applications such as electric vehicles.

Battery assemblies may include a number of individual cells assembled together in a closely packaged form such as in a battery pack. The cells may include any of several types of compositions for energy storage with lithium-ion being an example. The battery cells may be electrically connected in parallel or in series to deliver power to the application’s power consuming devices and for recharging. Each battery cell includes one or more electrodes. In some embodiments, each cell’s electrode pair may include a negative (anode) electrode and a positive (cathode) electrode.

In various applications, many cells may be collected together in close proximity to each other and assembled in a rechargeable energy storage system (RESS). When the cells are packaged together thermal management may be desirable, leading to the inclusion of devices for cooling and/or warming. Assembling a battery system includes challenges including delivering an efficiently functioning and thermally controlled assembly while maintaining a desirable level of tolerance variation in the positioning of individual cells and in the combined assembly. Maintaining acceptable geometric dimensioning and tolerancing is desirable for a variety of reasons including to effect correct electrical connections.

Accordingly, there is an ongoing desire to provide battery assemblies that deliver desirable operational and manufacturing effectiveness and efficiency, while controlling dimensions and providing a compact form. There is also a desire to provide efficient thermal management. Furthermore, other desirable features and characteristics of the present disclosure will become apparent from the subsequent detailed description and the appended claims, taken in conjunction with the accompanying drawings and the foregoing introduction.

### SUMMARY

In a number of embodiments, a method of thermal management and dimensional control of a battery system includes forming ribbons to remove heat from a battery system. Battery cells are assembled in rows with each row disposed between two of the ribbons. Prior to assembling the battery cells in rows, subassemblies are formed, each of which includes one of the ribbons and one of the rows of battery cells in a pre-bonded cell row. The battery cells of each subassembly are fixed to the one of the ribbons by a first thermal interface material. Plural of the subassemblies are stacked after the battery cells of each subassembly are fixed to their respective one of the ribbons as one of the pre-bonded cell rows. The battery cells of each subassembly are secured to the ribbon of another subassembly by a second thermal interface material to form a battery module.

In additional embodiments, the first thermal interface material is a first material having a first viscosity. The second thermal interface material is a second material having a second viscosity that is substantially higher in magnitude than the first viscosity.

In additional embodiments, an acrylic is selected as the first thermal interface material and one or more of a silicone, a urethane and an epoxy is selected as the second thermal interface material.

In additional embodiments, a first gap is set between each battery cell and its respective one of the ribbons. A second gap is set between each battery cell and the one of the ribbons of an adjacent of the pre-bonded cell rows. The first gap is set substantially smaller than the second gap.

In additional embodiments, the battery cells of a respective subassembly are held in position relative to one another by a tool prior to the pre-bonded cell row being formed.

In additional embodiments, the tool is closed when the pre-bonded cell row is formed to a closing height (H) of: H=Rt+t+Cd+∆T, where Rt is a thickness of the ribbon, t is a gap between the battery cells and the ribbon, Cd is a diameter of the battery cells and ∆T is a factor for tolerance variation of the ribbon, the battery cells and the tool.

In additional embodiments, each of the battery cells in the battery module is bonded to two of the ribbons to provide double faced cooling of each of the battery cells.

In additional embodiments, the battery module is coupled in a thermal management system that operates to circulate coolant through each of the ribbons in the battery module.

In additional embodiments, the battery cells are each formed in a cylindrical shape and the ribbons are formed in a serpentine shape.

In additional embodiments, a first gap is set between each battery cell and its respective one of the ribbons in its respective pre-bonded cell row. A second gap is set between the cell and the one of the ribbons of an adjacent of the pre-bonded cell rows, Dimensional location and providing cooling effectiveness is achieved by selecting the first gap and the second gap.

In a number of additional embodiments, a system for thermal management and dimensional control of a battery system includes ribbons that operate to remove heat from the battery system. Battery cells are disposed in rows with each row disposed between two of the ribbons. Subassemblies are formed, each of which includes one of the ribbons and one of the rows of battery cells in a pre-bonded cell row. The battery cells of each subassembly are fixed to the one of the ribbons by a first thermal interface material. Plural of the subassemblies are configured to be stacked, after the battery cells of each subassembly are fixed to their respective one of the ribbons as one of the pre-bonded cell rows, and secured thereto by a second thermal interface material to form a battery module.

In additional embodiments, the first thermal interface material is a first material having a first viscosity and the second thermal interface material is a second material having a second viscosity that is substantially higher in magnitude than the first viscosity.

In additional embodiments, the first thermal interface material is an acrylic and the second thermal interface material is at least one of a silicone, a urethane and an epoxy.

In additional embodiments, each battery cell has a first gap to its respective one of the ribbons and has a second gap to the one of the ribbons of an adjacent of the pre-bonded cell rows. The first gap is set substantially smaller than the second gap.

In additional embodiments, a tool operates to hold the battery cells of a respective subassembly is position relative to one another prior to the pre-bonded cell row being formed.

In additional embodiments, the tool is operates to close when the pre-bonded cell row is formed to a closing height (H) of: H=Rt+t+Cd+∆T, where Rt is a thickness of the ribbon, t is a gap between the battery cells and the ribbon, Cd is a diameter of the battery cells and ∆T is a factor for tolerance variation of the ribbon, the battery cells and the tool.

In additional embodiments, each of the battery cells in the battery module is bonded to two of the ribbons to provide double faced cooling of each of the battery cells.

In additional embodiments, a thermal management system operates to circulate coolant through each of the ribbons in the battery module.

In additional embodiments, each battery cell has a first gap to its respective one of the ribbons in it respective pre-bonded cell row, and has a second gap to the one of the ribbons of an adjacent of the pre-bonded cell rows. The first gap and the second gap are selected and controlled for dimensional location and cooling effectiveness.

In a number of other embodiments, a method includes forming ribbons for circulating fluid for thermal management of a battery system. Battery cells are assembled in rows forming subassemblies, each subassembly including one of the ribbons and one of the rows of the battery cells in a pre-bonded cell row as a bandolier. The bandolier includes the battery cells bonded to the one of the ribbons. Within each bandolier, the battery cells are spaced apart from one another and are all on a common side of the one of the ribbons. In a tool that holds the battery cells of a respective subassembly in position relative to one another, the battery cells of each subassembly are fixed to the one of the ribbons by a first thermal interface material. The first thermal interface material is set in the tool. Plural of the subassemblies are stacked after the battery cells of each subassembly are fixed to their respective one of the ribbons as one of the pre-bonded cell rows. The battery cells of each subassembly are secured to the ribbon of another subassembly by a second thermal interface material to form a battery module. The battery cells are assembled in rows with each of the rows disposed between two of the ribbons.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle including a cell system, in accordance with various embodiments;

FIG. 2 is schematic top view of a battery module of the vehicle of FIG. 1, in accordance with various embodiments;

FIG. 3 is a detail view of a part of the battery module of FIG. 2, in accordance with various embodiments;

FIG. 4a is a schematic illustration of a weld zone on a battery cell, in accordance with various embodiments;

FIG. 4b is a schematic illustration of a battery cell in a weld operation, in accordance with various embodiments;

FIG. 5 is a flowchart of a process for a bandolier cell system of the battery module of FIG. 2 and the vehicle of FIG. 1, in accordance with various embodiments;

FIG. 6 is a schematic illustration of cooling ribbon forming in a tool, in accordance with various embodiments;

FIG. 7 is a schematic illustration of a formed cooling ribbon in a tool, in accordance with various embodiments;

FIG. 8 is a schematic illustration of ribbon and manifold assembly, in accordance with various embodiments;

FIG. 9 is a schematic illustration of bonding material application to a bandolier, in accordance with various embodiments;

FIG. 10 is a schematic illustration of a tool holding cells and a ribbon, in accordance with various embodiments;

FIG. 11 is a detail view of the tool of FIG. 10 in a closed state, in accordance with various embodiments;

FIG. 12 is a schematic illustration of the application of a material to a bandolier, in accordance with various embodiments;

FIG. 13 is a schematic illustration of two bandoliers being joined, in accordance with various embodiments;

FIG. 14 is a schematic illustration of gaps adjacent a cell of the battery module of FIG. 2, in accordance with various embodiments;

FIG. 15 is a schematic illustration of a prismatic battery bandolier, in accordance with various embodiments; and

FIG. 16 is a schematic illustration of a pouch battery bandolier, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding introduction or the following detailed description.

In various embodiments, multi-surface (e.g., two-sided), broad face cooling provides high-performance thermal management in battery packs, such as those used in electric vehicles. Cells may be aggregated into an assembled collection or subassembly where they are linked together, such as in bandoliers, and then combined into larger units/modules and/or a complete battery pack. Plural battery cells may be affixed to a cooling/warming structure (ribbon or cooling ribbon) to maintain their positional relationships. This sub-assembly of battery cells and ribbon may be referred to as a pre-bonded cell row or as a bandolier whether or not shaped as such. For example, the individual cells may have a cylindrical, prismatic, pouch or another shape and the ribbon may be wavy/corrugated, flat, channeled, cavitied or otherwise shaped. Following the subassembly of the cells and the ribbon, multiple subassemblies/bandoliers are combined together and form a larger module or battery pack composed of linked individual cells in rows between ribbons. A tolerance management approach enables direct control of cell position during assembly by dividing the assembly process into modular steps. Various aspects of the approach provide a number of advantages as described herein.

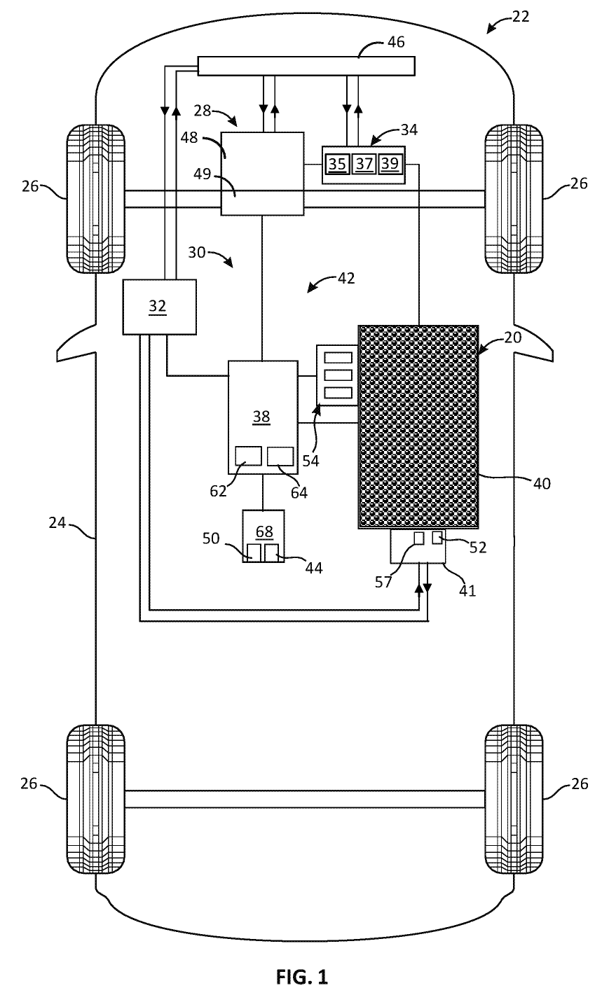

Referring to FIG. 1, an application within which a system, that is also referred to as a bandolier cell system 20, may be employed is illustrated as a vehicle 22. While the bandolier cell system 20 may be described within an embodiment of the vehicle 22, it is not limited to that embodiment but has application in a number of applications including in any environment where tolerance control of cell location and/or effective thermal management is desirable. As noted above, the system/bandolier cell system 20 as described herein may be applied to battery cells of any shape, size and chemistry/format.

As illustrated, the vehicle 22 includes a RESS 40 includes the bandolier cell system 20 according to an exemplary embodiment. The vehicle 22 includes control approaches that initiate cooling and/or warming through the bandolier cell system 20. The control may be in response to characteristics, such as those of the heat generated by the RESS 40 or to those related to low temperatures. In a number of embodiments, the vehicle 22 generally includes a body 24, four wheels 26, a powertrain 28, a control system 30, and the RESS 40. The body 24 substantially encloses the other components of the vehicle 22. The wheels 26 are each rotationally coupled to the body 24 near a respective corner. In some embodiments the control system 30 may be plural integrated systems.

The vehicle 22 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD). The vehicle 22 may also incorporate any one of, or combination of, a number of different types of electrical propulsion systems, such as a combustion/electric motor hybrid engine and a battery electric vehicle.

In the exemplary embodiment, the vehicle 22 is an electric vehicle, and generally includes a controller 38, the above-referenced RESS 40, the control system 30, the powertrain 28, and power electronics 34. The powertrain 28 embodies an electric propulsion system that drives the wheels 26. More specifically, the powertrain includes an electric motor 48. As will be appreciated by one skilled in the art, the electric motor 48 is associated with a geartrain 49 or transmission as an integral or separate component, and although not illustrated, also includes a stator assembly (including conductive coils), a rotor assembly (including a ferromagnetic core), and a cooling fluid or coolant. The power electronics 34 may include electric vehicle elements such as a power inverter module 35, an accessory power module 37 and an onboard charger module 39.

The RESS 40 is mounted on the body 24, and is electrically connected to the power electronics 34. In the current embodiment, the RESS 40 comprises at least one rechargeable battery pack having battery cells in the bandolier cell system 20 and is provided with thermal management. In embodiments, the cells of the RESS 40 may be cylindrical, prismatic, pouch, or of another type. Together, the RESS 40 and the powertrain 28 comprise a drive system to propel the vehicle 22. The RESS 40 is thermally conditioned including being thermally cooled and/or warmed through the bandolier cell system 20.

The vehicle 22 includes a thermal conditioning system 41 for cooling the RESS 40. In other embodiments, the thermal conditioning system 41 may warm the RESS 40. In general, the thermal conditioning system 41 includes a pump 52 and a sensor array 54, and may be controlled by the control system 30. In a number of embodiments, the thermal conditioning system 41 includes a valve array 57 for controlling fluid flows and in some embodiments may include a chiller. The thermal conditioning system 41 thermally conditions the RESS 40. Specifically, the thermal conditioning system 41 may utilize heating and cooling techniques, as appropriate, for heating or cooling the RESS 40, based on instructions provided by the controller 38, such as by a processor 62. The heating and cooling techniques are selected so as to attain a desired temperature of the RESS 40 while optimizing energy efficiency. The sensor array 54 may include temperature sensors and/or various state sensors, among other additional sensors.

Generally, the controller 38 is configured to receive inputs from various sensors which are configured to generate signals in proportion to various physical input parameters associated with: the powertrain 28; the heating, ventilating and air conditioning system 32; the RESS 40; and their subsystems, and other interrelated systems. In the depicted embodiment, the controller 38 includes the processor 62 and a memory device 64, and is coupled with a storage device 68. During operation, the processor 62 executes one or more programs 44 and may use data 50, each of which may be contained within the storage device 68.

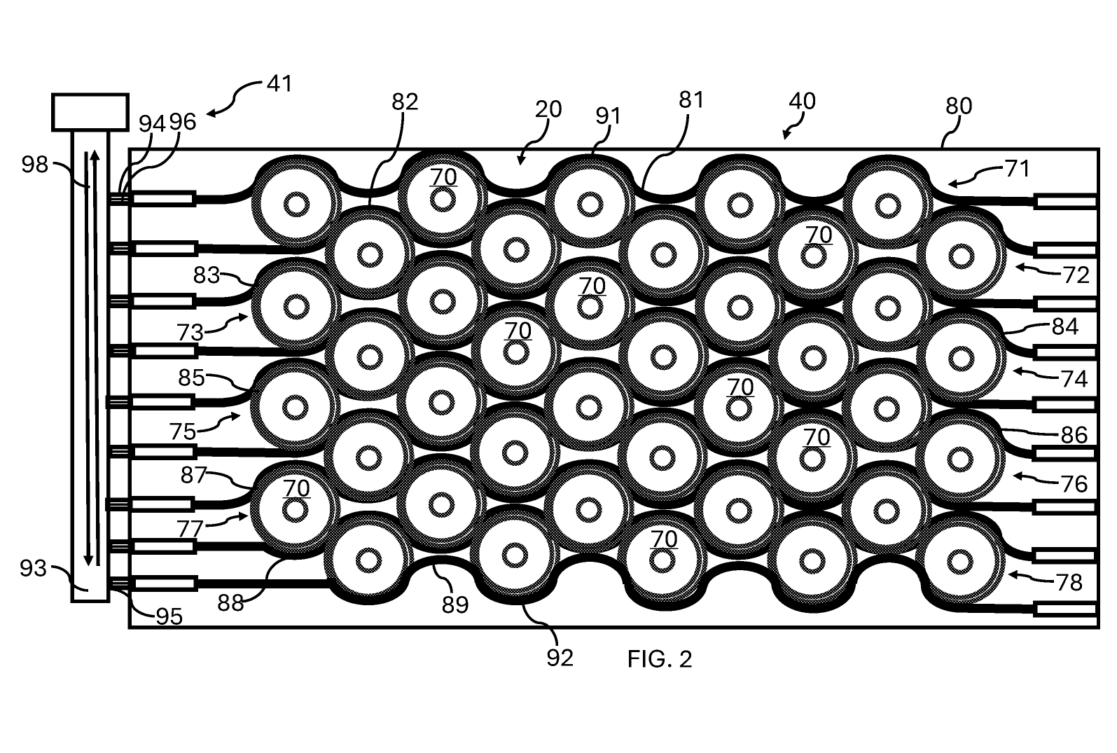

Within the context of the vehicle 22, the thermal conditioning system 41, including the bandolier cell system 20, effects cooling and/or warming of the RESS 40 by circulating at least one working fluid. Referring to FIG. 2, a part of the RESS 40 with the bandolier cell system 20 is schematically illustrated and is referred to as a module 80. The cells 70 in this embodiment are cylindrical cells. Any available format and size of the cells 70 may be employed. In general, the cells 70 are electrically coupled together (not shown) and with other components to supply power and for recharging. The chemistry of the cells 70 may be lithium-ion or any other available chemistry or type. The cells 70 are generally arranged in rows 71-78 that are offset from one another for packaging considerations. The number of cells 70 in each of the rows 71-78 is selected according to the parameters of the application.

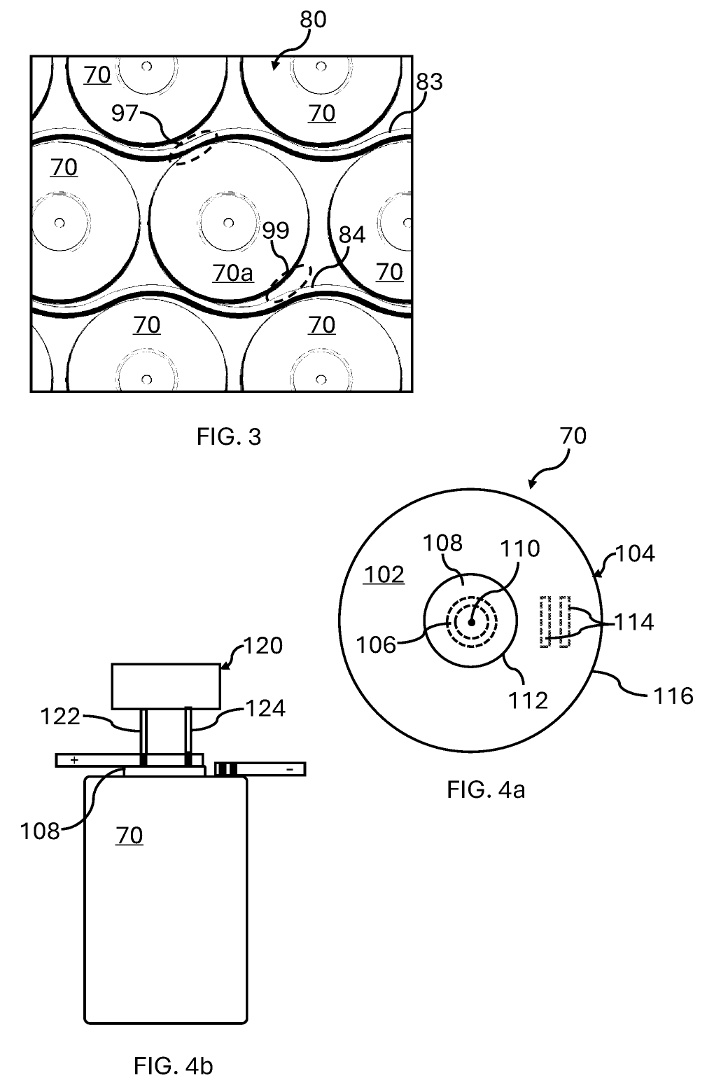

The cells 70 are provided with double faced cooling meaning that a cooling/warming structure (ribbon) is disposed on two sides of each cell 70. The use of double faced or double sided ribbon cooling may exacerbate geometric dimensioning and tolerancing challenges as further described below in relation to FIG. 3. In embodiments, any number of cells 70 may be assembled together to form a module or pack, using any number of ribbons. In this embodiment, each cell 70 is cylindrical in shape and each ribbon is serpentine (wavy) in shape.

In the example of FIG. 2, one respective thermal management ribbon 81-89 is disposed on each side of the rows 71-78. Specifically, thermal management ribbon 81 is disposed on a side 91 of the row 71. A thermal management ribbon 82 is disposed between the rows 71 and 72. One thermal management ribbon 83 is disposed between the rows 72 and 73. Another thermal management ribbon 84 is disposed between the rows 73 and 74. Another thermal management ribbon 85 is disposed between the rows 74 and 75. Another thermal management ribbon 86 is disposed between the rows 75 and 76. Another thermal management ribbon 87 is disposed between the rows 76 and 77. Another thermal management ribbon 88 is disposed between the rows 77 and 78. Another thermal management ribbon 89 is disposed on a side 92 of the row 78. In applications, additional or fewer thermal management ribbons may be used. Each thermal management ribbon 81-89 includes a coolant inlet 94 and a coolant outlet 96. The coolant 98 may be circulated through the ribbons 81-89 for cooling and/or warming.

The ribbons 81-89 are coupled with a header 93 that is connected with, or a part of, the thermal conditioning system 41. The header 93 directs fluid for an exchange into and out of the ribbons 81-89. The header 93 includes ports 95 that require alignment with the ribbons 81-89. In embodiments, separate supply and return headers may be provided with one on each side of the module 80. During thermal conditioning, the fluid is circulated through the ribbons 81-89 for movement of the exchanged heat.

Referring to FIG. 3, the location of each cell 70 within the module 80 is desirably controlled to avoid tolerance stack that may result in a cell 70 being to far away from its adjacent ribbon (e.g., 83, 84) and/or from being in interference with the location of an adjacent ribbon (e.g., 83, 84). Stack-up as the cells 70 and the ribbons 81-89 are assembled together may accumulate between locations of the cells 70, profiles of the ribbons 81-89 and locations of the ribbons 81-89. For example, variation within allowable tolerances may result in a cell 70a being disposed with an interference condition with the ribbon 83 at an area 97 and/or an excessive gap condition with the ribbon 84 at an area 99. The interference conditions may undesirably result in ribbon deformation or displacement. Excessive gap conditions may undesirably result in reduced thermal transfer. To avoid interference and excessive gaps, the bandolier cell system 20 provides gap control.

In addition to interference conditions and excessive gap conditions, FIGS. 4a and 4b illustrate an advantage to controlling location of the cells 70 for electrical connection purposes. During assembly of the module 80, cell interconnections may be made and/or an interconnect board (ICB) may be assembled in the module 80 to effect electrical connections at the cover 102 of the case 104 of a cell 70. For example, certain connections may be made at a weld zone 106 that encircles a raised rivet 108 in the center of the cover 102. In this example, as shown in FIG. 4a, the weld zone 106 is spaced from the center point 110 of the raised rivet 108, is spaced from the rim 112 of the raised rivet 108, and is defined with tolerance limits. Another weld zone 114 is spaced outward from the raised rivet 108, is spaced from the rim 116 of the case 104, and is defined with tolerance limits. As shown in FIG. 4b, the welding may be accomplished by a machine 120 that in this case has at least one effector to deliver welding energy, which in this example is electrodes 122 and 124. In embodiments, resistance, laser, ultrasonic, pulsed arc, or other joining approaches may be employed by the machine 120. FIG. 4b shows welding of the positive connections and the negative connections may be similarly welded. In order for the welds effected to be within the tolerance limits of the weld zones 106 and 114, the cells 70 must be properly located in the module 80. Accordingly, the bandolier cell system 20 provides such locating.

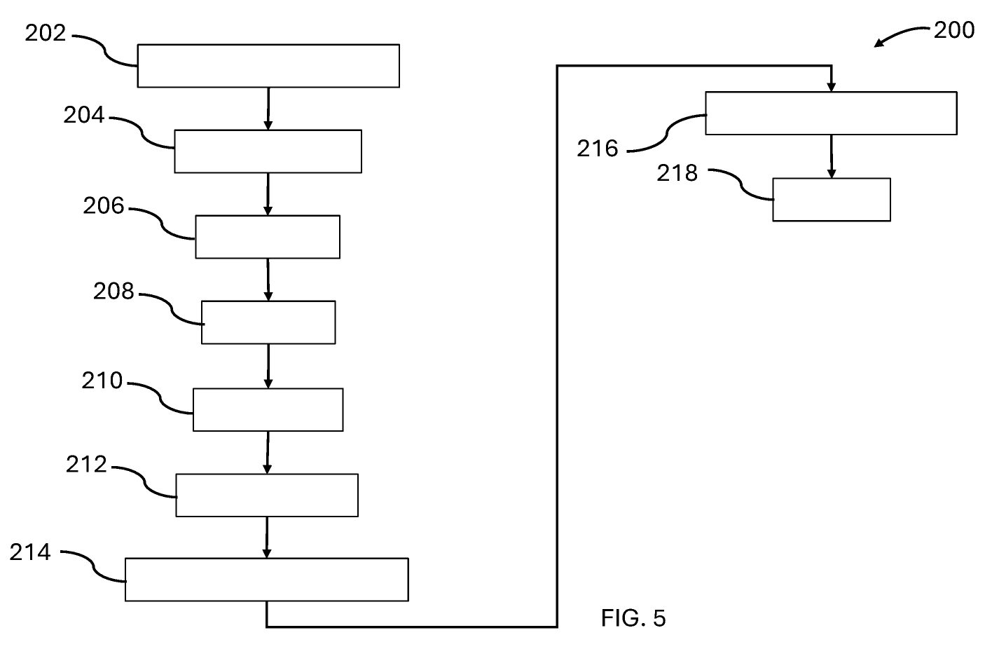

Referring to FIG. 5, a method 200 using the bandolier cell system 20 is depicted in flow chart form. As will be appreciated in light of the disclosure, the order of operation within the method 200 is not limited to the sequential execution as illustrated in FIG. 5 but may be performed in one or more varying orders as applicable and in accordance with the present disclosure. In addition, in any given step, additional or fewer steps, procedures and/or components may be involved. It will also be appreciated that preliminary operations such as forming and machining components and assembling subassemblies may be completed in advance in preparation for those steps described herein. An example includes fabricating components and assembling the cells 70 in advance.

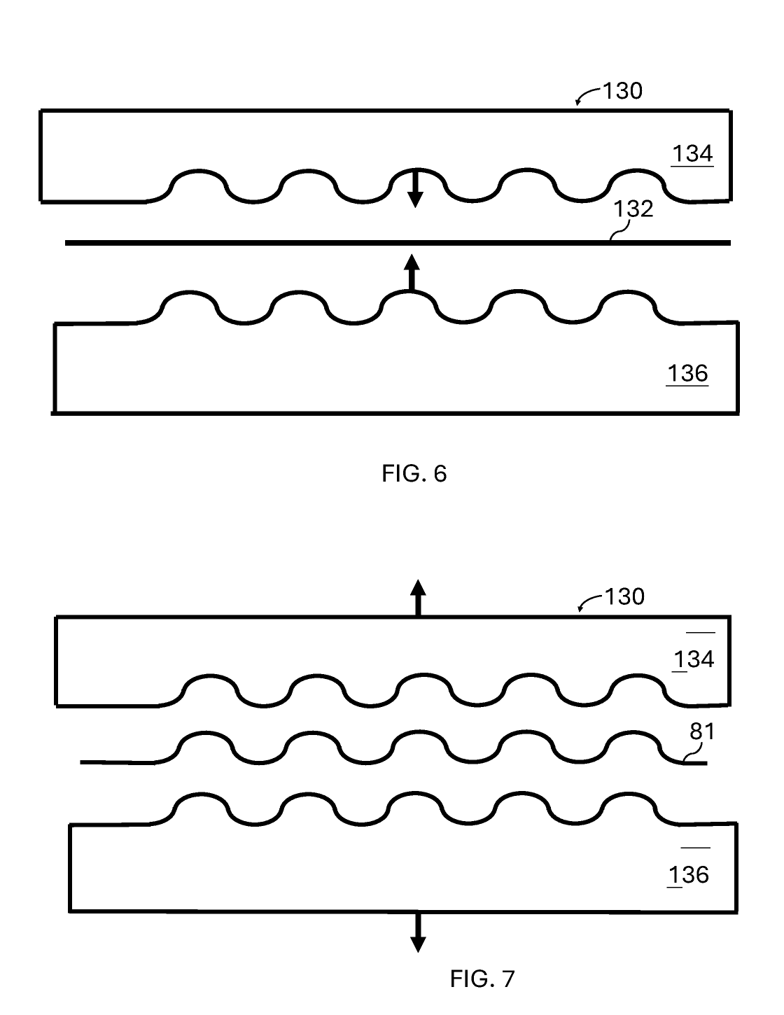

As shown in FIG. 5, the first illustrated step includes forming 202 the cooling ribbons 81-89. As shown in FIG. 6, the ribbons 81-89 may be formed in a machine 130, which in this case is a die/press. In other embodiments, the machine 130 may be a bender, roll former, or other machinery. The ribbons 81-89 each start as a blank 132 that is a straight section of stock with internal longitudinal or other shaped channels for fluid flow. The halves 134 and 136 of the machine 130 are brought together and act on the blank 132 for forming. As shown in FIG. 7, when the halves 134 and 136 are reopened the blank 132 has been formed into the ribbon 81. In embodiments, the ribbon 81 may be formed in any desired shape.

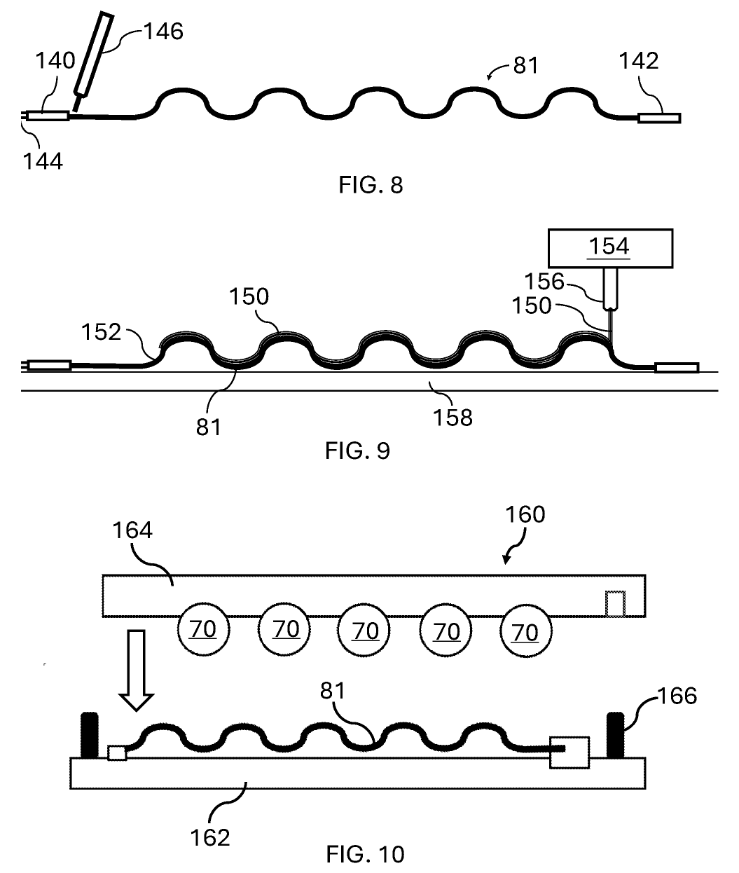

With the ribbon 81 formed to the desired shape to mate with the cells 70, manifolds 140 and 142 are added 204 to the ends of the ribbon 81 as part of the method 200 and as shown in FIG. 8. The manifold 140 directs fluid into and out of the ribbon 81 and has a coupling 144 for coupling with the header 93 (FIG. 2). The manifold 142 turns fluid flowing through half of the ribbon 81 from left to right as viewed to return to the manifold 140 through the ribbon 81. The manifolds 140 and 142 may be joined to the ribbon 81 by means such as welding via a welder 146.

The method 200 proceeds with applying 206 thermal interface material (TIM) 150 to the ribbon 81 along its surface 152 as shown in FIG. 9. The TIM 150 may be any material that is added between the cells 70 and the ribbons 81-89 to provide thermal coupling between them. In embodiments, the TIM 150 may also bond the cells 70 to the ribbons 81-89. In embodiments, the TIM 150 may be a two component mixture, such as with two components including a resin and a hardener. The application 206 of the TIM 150 may be accomplished by an applicator 154 that dispenses the TIM through a nozzle 156 with the ribbon 81 positioned on a fixture 158. The applicator 154 may be a machine that is automatically moved across the surface 152 and that mixes and meters the TIM 150 that is applied.

In the method 200, while the TIM 150 is within its working state, a row of cells 70 may be added 208 to the ribbon 81 at the applied TIM 150. FIG. 10 shows that this may be accomplished with a tool 160, which assists with dimensional control. The tool 160 includes a fixture 162 on which the ribbon 81 is mounted in a controlled location. For example, locating features such as pins, blocks, contoured surfaces, etc. may be employed to locate the ribbon 81 at a defined place within all degrees of freedom. Once positioned, the ribbon 81 may be clamped or otherwise held in place. The tool 160 includes a fixture 164 on which a number of the cells 70 are located. The fixture 164 locates the cells 70 is position relative to each other according to their design locations in the assembled module 80. The tool 160 controls the position of the cells 70 relative to each other and relative to the ribbon 81.

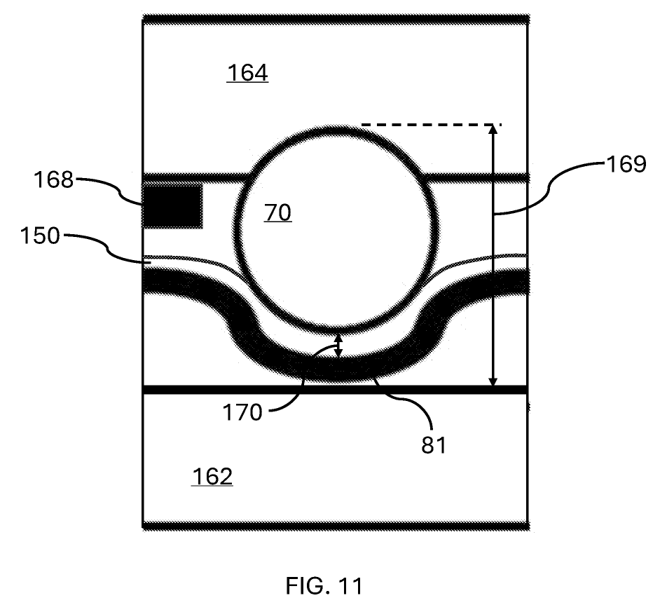

As shown in FIG. 11, the fixtures 162 and 164 are brought together and a number of guides 166 (FIG. 10) align the fixtures 162 and 164. The line of cells 70 is then set to the ribbon 81 as the TIM 150 cures. In embodiments, the open time of the TIM 150 may be one to two minutes. The fixtures 162 and 164 have at least one stop 168 that defines the distance (H) 169 between the fixtures 162 and 164 to press the cells 70 into the applied TIM 150 leaving a gap 170. The gap 170 is defined by the product’s design requirements and is established by H=Rt+t+Cd+∆T, where Rt is the thickness of the ribbon 81, t is the gap 170, Cd is the diameter of the cells 70 and ∆T is a factor for tolerance variation of the ribbon 81, cell 70, the gap 170 and/or the tool 160. Stopping closure of the fixtures 162, 164 at the distance H 169 sets the gap 170 at the defined magnitude for dimensional control and for operation of the selected TIM 150. In embodiments, the gap 170 may be in the range of 0.0-0.5 millimeters. In other embodiments, the gap 170 may be larger. After the TIM 150 is set, the fixtures 162 and 164 are separated. The setting of the TIM 150 is accomplished within the tool 160 to maintain relative locations. The addition 208 step according to the bandolier cell system 20 datums the cells 70 to the ribbon 81 and holds them in precise location during further processing.

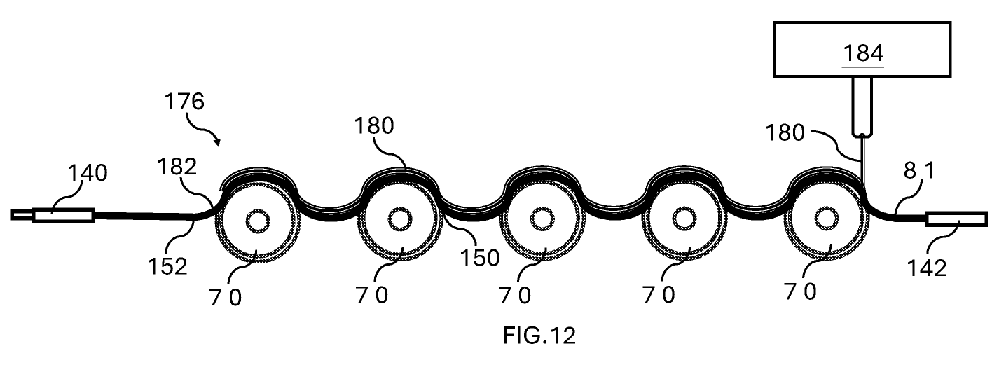

Following the addition 208 of the cells 70 to the ribbon 81 a bandolier 176, such as shown in FIG. 12, is created. The bandolier 176 includes the ribbon 81 with manifolds 140 and 142 added and a number of cells 70 adhered to the ribbon 81 by the TIM 150 at defined locations according to the product’s dimensional requirements and on the side of the surface 152 of the ribbon 81. As shown in FIG. 12, the method 200 includes applying TIM 180 to the surface 182 of the ribbon 81. The surface 182 is on an opposite side of the ribbon 81 from the surface 152. In embodiments the TIM 180 may be a different material than the TIM 150 as further described below, or may be the same material depending on requirements of the module 80. The TIM 180 may be applied by a machine 184 similar to the applicator 154.

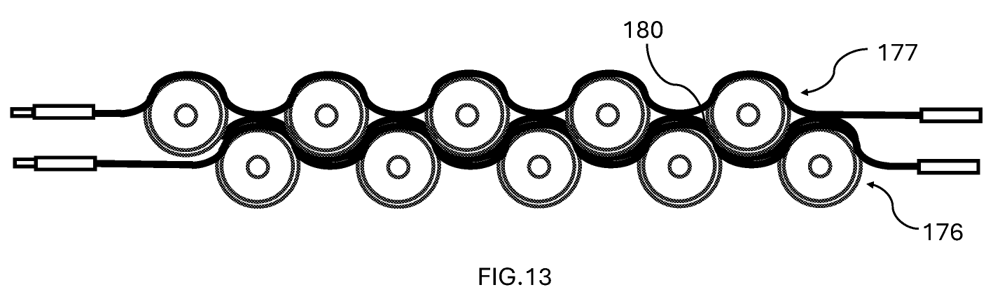

As shown in FIG. 13, in the method 200 another bandolier 177 (and others) may have been created similar to the bandolier 176. The bandolier 177 is added 212 to the bandolier 176 and pressed into the TIM 180. Fixturing may be used similar to the tool 160 of FIG. 10, which may include two fixtures similar to the fixture 164 to control relative location. The gap 186 at the TIM 180 is set by the tooling. The gap 186 may be in the range of up to approximately 2 millimeters. In other embodiments, the gap 186 may be a different size and may be the same size as the gap 170. This assembly step may be repeated with the addition 212 of more bandoliers until the module 80 has its full complement of bandoliers according to its design.

In the method 200, the assembled bandoliers 176, 177, et al. are then assembled 214 into the battery pack of the RESS 40 and assembled 216 into the vehicle 22. The RESS 40 is then operated 218 such as via the thermal conditioning system 41.

In the operation 218, the thermal conditioning system 41 provides active cooling and thermal management by regulating the temperature of the RESS 40. In embodiments, cooling is provided when needed, such as in hot weather conditions. In embodiments, warming may be provided, such as in cold weather conditions and/or a cold start of the vehicle 22. Liquid is circulated through the ribbons 81-89 of the bandoliers in the RESS 40 to move heat.

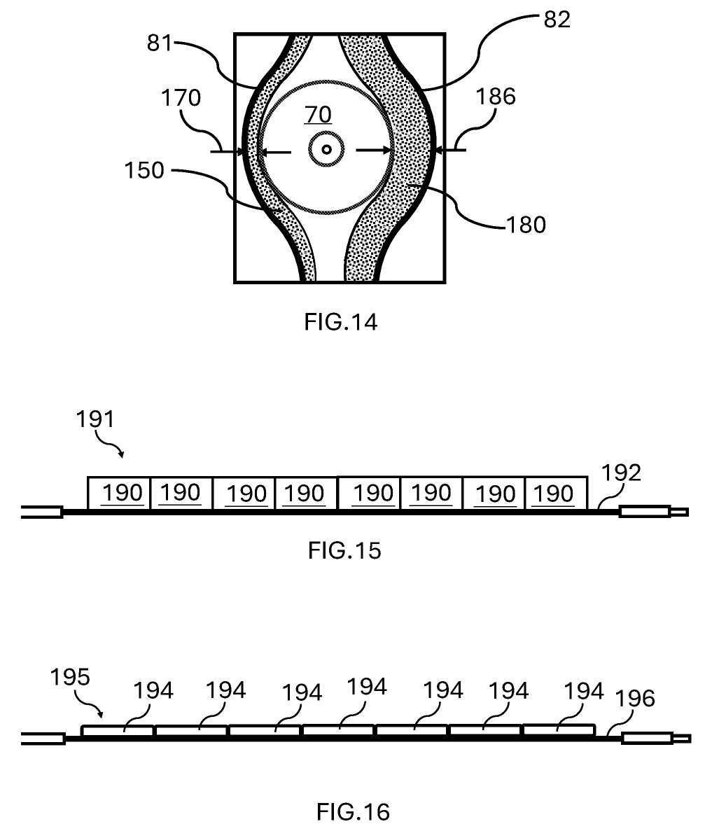

In embodiments, the bandolier cell system 20 facilitates the use of different materials for the TIM 150 and for the TIM 180 and/or the use of different sized gaps being provided to the ribbons on opposite sides of a cell 70. Referring to FIG. 14, a cell 70 is shown in its final assembled state between the ribbons 81 and 82. The TIM 150 is disposed between the ribbon 81 and the cell 70 and the TIM 180 is disposed between the ribbon 82 and the cell 70. The TIM 150 and the TIM 180 extend along a significant part of the surface of the cell 70 for broad faced thermal exchange.

In a dual TIM strategy, a relatively thin TIM material may be used for the TIM 150. As shown in FIG. 14 the gap 170 may be in the range of 0.0 – 0.5 millimeters. In other embodiments, the gap 170 may have a different size. The TIM 150 may be a low viscosity adhesive type TIM. In embodiments, the TIM 150 may be an acrylic such as polymethyl methacrylate, with a viscosity in the range of 40-95 centipoise. This relatively low viscosity means the TIM 150 wicks into the gap and flows easily during the addition 208 of the cells 70 to the ribbon 81. The TIM 150 may move as a result of wicking and pressing actions. As part of the method 200 the TIM 150 cures quickly without externally applied heat. In embodiments, the addition of heat or other accelerants may be used to reduce cure time. Thermal conductivity of the TIM 150 is approximately 0.1-0.3 watt per meter-kelvin (W/mK) enabling desirable thermal management given the size of the gap 170.

In the embodiment of FIG. 14, the gap 186 may be in the range of up to approximately 2 millimeters. The gap 186 may be defined in magnitude according to the thermal management needs of the system and according to the tolerances of the module 80. In this embodiment, the TIM 180 may be a gap filler/adhesive type TIM. In embodiments, the TIM 180 may be silicone, urethane, epoxy, or another material. In embodiments, the TIM 180 may be a two component material, such as including a filler/adhesive and a hardener. In embodiments, the size of the gaps 170 and 186 may be balanced to achieve desired heat transfer requirements.

In embodiments, the two TIM strategy may be used when the gaps 170 and 186 are the same, or approximately the same, size and the choice of materials may be tailored to the resulting gap size and heat transfer requirements. The bandolier cell system 20 enables a larger size gap 186 as compared to the gap 170 with locations tightly controlled at the addition step 212 of the method 200. This in-turn, enables accommodating more tolerance variation in the gap 186 ensuring that interference fit and excessive gap size occurrences are avoided. In other words, a majority of the geometric dimensioning and tolerancing is accommodated in one bond with the cells 70 instead of two. As a result, thermal management and the electrical connections, such as with the ICB 100 are facilitated.

In addition to cylindrical cells 70, other types of cells may be used in the bandolier cell system 20. Referring to FIG. 15, an embodiment including prismatic cells 190 is illustrated as an example. The cells 190 may be assembled in a bandolier 191. The ribbon 192 is straight, or substantially straight, to accommodate the shape of the cells 190. Multiple bandoliers 191 may be preassembled and then aggregated as in the method 200.

An additional embodiment is illustrated in FIG. 16 with pouch cells 194. A bandolier 195 is formed with the cells 194 and a ribbon 196. The ribbon 196 is straight, or substantially straight, to accommodate the cells 194. Multiple bandoliers 195 may be preassembled and then aggregated as in the method 200. In other embodiments, the cells may have a different shape and the ribbons have a shape to accommodate the cells.

Accordingly, cell position is controlled while providing double faced cell cooling. Benefits include reducing component and assembly complexity by reducing the total number of unconstrained components during cell and ribbon assembly via pre-curing cells to ribbons in bandoliers by TIM bonds. A modular assembly process is used to reduce requirements of sequencing unique components. Errors are reduced by avoiding buildup of tolerance stacking. Modular bandolier are formed that are pre-assembled into sub-assemblies. Subassembly bonding is complete while components are held in position with tooling during bandolier formation. Assembly strength may be increased during the manufacturing process though pre-curing a portion of cell-ribbon bonds, reducing need for cure buffers or brace tooling to maintain component relations. The subassembled bandoliers are then assembled into a battery stack such as in a module or RESS.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
forming ribbons to remove heat from a battery system;
assembling battery cells in rows with each row disposed between two of the ribbons;
prior to assembling the battery cells in rows, forming subassemblies, each of which includes one of the ribbons and one of the rows of battery cells in a pre-bonded cell row;
fixing the battery cells of each subassembly to the one of the ribbons by a first thermal interface material;
stacking plural of the subassemblies, after the battery cells of each subassembly are fixed to their respective one of the ribbons as one of the pre-bonded cell rows; and
securing the battery cells of each subassembly to the ribbon of another subassembly by a second thermal interface material to form a battery module.

2. The method of claim 1, comprising:
selecting, as the first thermal interface material, a first material having a first viscosity; and
selecting, as the second thermal interface material, a second material having a second viscosity that is substantially higher in magnitude than the first viscosity.

3. The method of claim 1, comprising:
selecting an acrylic as the first thermal interface material; and
selecting at least one of a silicone, a urethane and an epoxy as the second thermal interface material.

4. The method of claim 1, comprising:
setting a first gap between each battery cell and its respective one of the ribbons; and
setting a second gap between each battery cell and the one of the ribbons of an adjacent of the pre-bonded cell rows, wherein the first gap is set substantially smaller than the second gap.

5. The method of claim 1, comprising:
holding, in a tool, the battery cells of a respective subassembly in position relative to one another prior to the pre-bonded cell row being formed.

6. The method of claim 5, comprising closing the tool when the pre-bonded cell row is formed to a closing height (H) of: H=Rt+t+Cd+∆T, where Rt is a thickness of the ribbon, t is a gap between the battery cells and the ribbon, Cd is a diameter of the battery cells and ∆T is a factor for tolerance variation of the ribbon, the battery cells and the tool.

7. The method of claim 1, comprising bonding each of the battery cells in the battery module to two of the ribbons to provide double faced cooling of each of the battery cells.

8. The method of claim 1, comprising coupling the battery module in a thermal management system configured to circulate coolant through each of the ribbons in the battery module.

9. The method of claim 1, comprising forming the battery cells each in a cylindrical shape; and forming the ribbons in a serpentine shape.

10. The method of claim 1, comprising:
setting a first gap between each battery cell and its respective one of the ribbons in its respective pre-bonded cell row;
setting a second gap to the one of the ribbons of an adjacent of the pre-bonded cell rows; and
controlling dimensional location and providing cooling effectiveness by selecting the first gap and the second gap.

11. A system comprising:
ribbons configured to remove heat from the battery system;
battery cells disposed in rows with each row disposed between two of the ribbons; and
subassemblies, each of which includes one of the ribbons and one of the rows of
battery cells in a pre-bonded cell row;
wherein the battery cells of each subassembly are fixed to the one of the ribbons by a first thermal interface material;
wherein plural of the subassemblies are configured to be stacked, after the battery cells of each subassembly are fixed to their respective one of the ribbons as one of the pre-bonded cell rows, and secured thereto by a second thermal interface material to form a battery module.

12. The system of claim 11, wherein the first thermal interface material comprises a first material having a first viscosity and the second thermal interface material comprises a second material having a second viscosity that is substantially higher in magnitude than the first viscosity.

13. The system of claim 11, wherein the first thermal interface material comprises an acrylic and the second thermal interface material comprises at least one of a silicone, a urethane and an epoxy.

14. The system of claim 11, wherein each battery cell has a first gap to its respective one of the ribbons and has a second gap to the one of the ribbons of an adjacent of the pre-bonded cell rows, wherein the first gap is set substantially smaller than the second gap.

15. The system of claim 11, comprising a tool configured to hold the battery cells of a respective subassembly in position relative to one another prior to the pre-bonded cell row being formed.

16. The system of claim 15, wherein the tool is configured to close when the pre-bonded cell row is formed to a closing height (H) of: H=Rt+t+Cd+∆T, where Rt is a thickness of the ribbon, t is a gap between the battery cells and the ribbon, Cd is a diameter of the battery cells and ∆T is a factor for tolerance variation of the ribbon, the battery cells and the tool.

17. The system of claim 11, wherein each of the battery cells in the battery module is bonded to two of the ribbons to provide double faced cooling of each of the battery cells.

18. The system of claim 11, comprising a thermal management system configured to circulate coolant through each of the ribbons in the battery module.

19. The system of claim 11, wherein each battery cell has a first gap to its respective one of the ribbons in it respective pre-bonded cell row, and has a second gap to the one of the ribbons of an adjacent of the pre-bonded cell rows, wherein the first gap and the second gap are selected and controlled for dimensional location and cooling effectiveness.

20. A method comprising:
forming ribbons for circulating fluid for thermal management of a battery system;
assembling battery cells in rows forming subassemblies, each subassembly including one of the ribbons and one of the rows of the battery cells in a pre-bonded cell row as a bandolier, wherein the bandolier includes the battery cells bonded to the one of the ribbons, and wherein, within each bandolier, the battery cells are spaced apart from one another and are all on a common side of the one of the ribbons;
fixing, in a tool that holds the battery cells of a respective subassembly in position relative to one another, the battery cells of each subassembly to the one of the ribbons by a first thermal interface material;
setting the first thermal interface material in the tool;
stacking plural of the subassemblies, after the battery cells of each subassembly are fixed to their respective one of the ribbons as one of the pre-bonded cell rows; and
securing the battery cells of each subassembly to the ribbon of another subassembly by a second thermal interface material to form a battery module, wherein the battery cells are assembled in rows with each of the rows disposed between two of the ribbons.
